(19) United States
(12) Patent Application Publication
(10) Pub. No.: US 2018/0082433 A1
(43) Pub. Date: Mar. 22, 2018

(54) METHOD AND SYSTEM FOR REGISTERING ULTRASOUND AND COMPUTED TOMOGRAPHY IMAGES

(71) Applicants: CENTRE FOR IMAGING TECHNOLOGY COMMERCIALIZATION (CIMTEC), London (CA); THE UNIVERSITY OF WESTERN ONTARIO, London (CA)

(72) Inventors: Eliezer Azi Ben-Lavi, London (CA); Aaron Fenster, London (CA)

(21) Appl. No.: 15/558,489

(22) PCT Filed: Mar. 31, 2015
(86) PCT No.: PCT/CA2015/000211

§ 371 Date: Sep. 14, 2017

(51) Int. Cl. G06T 7/33; G06T 3/00; G06T 5/20; G06T 15/08

(52) U.S. Cl. CPC G06T 7/33; G06T 3/0068; G06T 5/20; G06T 2207/20024; G06T 2207/10081; G06T 2207/10136; G06T 15/08

(57) ABSTRACT

A method for registering ultrasound (US) and computed tomography (CT) images, comprising: receiving US and CT images representative of a body portion comprising blood vessels and an initial approximate transform; enhancing the blood vessels in the US and CT images, thereby obtaining an enhanced US and CT images; creating a point-set for a given one of the enhanced US and CT images; determining a final transform between the point-set and the other one of the enhanced US and CT images using the initial transform; applying the final transform to a given one of the US and CT images to align together a coordinate system of the US image and a coordinate system of the CT image, thereby obtaining a transformed image; and outputting the transformed image.

### CROSS-REFERENCE TO RELATED APPLICATIONS

This is the first application filed for the present invention.

### TECHNICAL FIELD

The present invention relates to the field of medical image registration, and more particularly to the registration of ultrasound and computer tomography images.

### BACKGROUND

Image registration is the process of transforming different sets of data into a given coordinate system. In the field of medical images, image registration allows ensuring that two different images taken using two different imaging techniques or modalities for example will share a same coordinate system so that they may be compared and used by a technician or physician.

Registering ultrasound images such as three-dimensional (3D) ultrasound images and computer tomography (CT) images such as contrast enhanced CT images may be challenging since ultrasound and CT images correspond to different modalities and different elements are associated with the voxels of these two types of images. In 3D ultrasound images, the acoustic impedance and physical density values are associated with each voxel while an attenuation coefficient value is associated with each voxel for CT images.

Taking the example of a liver imaged by ultrasonography and CT, the appearance of the liver in both modalities is very different which may prevent the use of standard metric based registration methods such as Normalized Cross Correlation (NCC), Mean Squared Difference (MSD), Mutual Information (MI), or the like.

Therefore, there is a need for an improved method and system for registering ultrasound and CT images.

### SUMMARY

According to a first broad aspect, there is provided a computer-implemented method for registering an ultrasound (US) image and a computed tomography (CT) image together, comprising: use of at least one processing unit for receiving a three-dimensional (3D) US image representative of a body portion comprising blood vessels, a contrast enhanced CT image representative of the body portion, and an initial transform providing an approximate registration of the 3D US and contrast enhanced CT images together; use of the at least one processing unit for enhancing the blood vessels in each one of the 3D US and contrast enhanced CT images, thereby obtaining a vessel enhanced US image and a vessel enhanced CT image; use of the at least one processing unit for creating a point-set for a given one of the vessel enhanced US and CT images; use of the at least one processing unit for determining a final transform between the point-set and the other one of the vessel enhanced US and CT images using the initial transform; use of the at least one processing unit for applying the final transform to a given one of the 3D US and enhanced contrast CT images to align together a coordinate system of the 3D US image and a coordinate system of the enhanced contrast CT image, thereby obtaining a transformed image; and use of the at least one processing unit for outputting the transformed image.

In one embodiment, the step of enhancing the blood vessels comprises, for each voxel of each one of the 3D US and contrast enhanced CT images: determining a vesselness value indicative of a probability for the voxel to correspond to one of the blood vessels; and assigning the determined vesselness value to the voxel, thereby obtaining a preprocessed US image and a preprocessed CT image.

In one embodiment, the step of enhancing said blood vessels comprises for each one of the preprocessed US and preprocessed CT images: generating a binary mask comprising high vessel probability voxels and low vessel probability voxels; and applying the binary mask to a respective one of the preprocessed CT and preprocessed US images.

In one embodiment, the step of generating the binary mask comprises: comparing the vesselness value of each voxel to a first predefined value; assigning a first mask value to first voxels of the binary mask having a vesselness value being less than the first predefined value, thereby obtaining the low vessel probability voxels; and assigning a second mask to second voxels of the binary mask having a vesselness value being one of equal to and greater than the first predefined value, thereby obtaining the high vessel probability voxels, the second mask value being different from the first mask value.

In one embodiment, the step of applying the binary mask comprises assigning a zero vesselness value to voxels of the respective one of the preprocessed CT and preprocessed US images that correspond to the low vessel probability voxels in the binary mask.

In one embodiment, the method further comprises a step of identifying isolated voxels among the high vessel probability voxels and assigning the first mask value to the isolated voxels.

In one embodiment, the step of creating a point-set comprises: comparing the vesselness value of each voxel to a second predefined value; identifying given voxels having a vesselness value being greater than the predetermined value; and storing the given voxels, thereby obtaining the point-set.

In one embodiment, the step of creating the point-set comprises creating a CT point-set from the vessel enhanced CT image; the step of determining the final transform comprises determining the final transform between the CT point-set and the vessel enhanced US image; the step of applying the final transform comprises applying the final transform to the 3D US image, thereby obtaining a registered US image; and the step of outputting the transformed image comprises outputting the registered US image.

In one embodiment, the method further comprises a step of resampling at least one of the 3D US and contrast enhanced CT images.

According to a second broad aspect, there is provided a computer program product comprising a computer readable memory storing computer executable instructions thereon that when executed by a computer perform the steps of the above method steps.

According to another broad aspect, there is provided a computer-implemented method for determining a transform for registering an ultrasound (US) image and a computed tomography (CT) image together, comprising: use of at least one processing unit for receiving a three-dimensional (3D) US image representative of a body portion comprising blood vessels, an enhanced contrast CT image representative of the body portion, and an initial transform providing an approximate registration of the 3D US and enhanced contrast CT images together; use of the at least one processing unit for enhancing the blood vessels in each one of the 3D US and enhanced contrast CT images, thereby obtaining a vessel enhanced US image and a vessel enhanced CT image; use of the at least one processing unit for creating a point-set for a given one of the vessel enhanced US and CT images; use of the at least one processing unit for determining a final transform between the point set and the other one of the vessel enhanced US and CT images using the initial transform, the final transform allowing to align a coordinate system of the 3D US image and a coordinate system of the enhanced contrast CT image together; and use of the at least one processing unit for outputting the final transform.

According to a further broad aspect, there is provided a system for registering an ultrasound (US) image and a computed tomography (CT) image together, comprising: an enhancing filter for receiving a three-dimensional (3D) US image representative of a body portion comprising blood vessels and a contrast enhanced CT image representative of the body portion, and enhancing the blood vessels in each one of the 3D US and contrast enhanced CT images to obtain a vessel enhanced US image and a vessel enhanced CT image; a point-set generator for creating a point-set for a given one of the vessel enhanced US and CT images; a transform determination unit for receiving an initial transform providing an approximate registration of the 3D US and contrast enhanced CT images together and determining a final transform between the point set and the other one of the vessel enhanced US and CT images using the initial transform; and a transform application unit for applying the final transform to a given one of the 3D US and contrast enhanced CT images to align together a coordinate system of the 3D US image and a coordinate system of the contrast enhanced CT image to obtaining a registered image, and for outputting the registered image.

In one embodiment, the enhancing filter is adapted to, for each voxel of each one of the 3D US and contrast enhanced CT images: determine a vesselness value indicative of a probability for the voxel to correspond to one of the blood vessels; and assign the determined vesselness value to the voxel to obtain a preprocessed US image and a preprocessed CT image.

In one embodiment, the enhancing filter is adapted to, for each one of the preprocessed US and preprocessed CT images: generate a binary mask comprising high vessel probability voxels and low vessel probability voxels; and apply the binary mask to a respective one of the preprocessed CT and preprocessed US images.

In one embodiment, the enhancing filter is adapted to generate the binary mask by: comparing the vesselness value of each voxel to a first predefined value; assigning a first vesselness value to first voxels of the binary mask having a vesselness value being less than the first predefined value, thereby obtaining the low vessel probability voxels; and assigning a second value to second voxels of the binary mask having a vesselness value being one of equal to and greater than the first predefined value, thereby obtaining the high vessel probability voxels, the second mask value being different from the first mask value.

In one embodiment, the enhancing filter is adapted to apply the binary mask by assigning a zero vesselness value to voxels of the respective one of the preprocessed CT and preprocessed US images that correspond to the low vessel probability voxels of the binary mask.

In one embodiment, the enhancing filter is further adapted to identify isolated voxels among the high vessel probability voxels and assign the first mask value to the isolated voxels.

In one embodiment, the point-set generator is adapted to: compare the vesselness value of each voxel to a second predefined value; identify given voxels having a vesselness value being greater than the predetermined value; and store the given voxels, thereby obtaining the point-set.

In one embodiment, the point-set generator is adapted to create a CT point-set from the vessel enhanced CT image; the transform determination unit is adapted to determine the final transform between the CT point-set and the vessel enhanced US image; and the transform application unit is adapted to apply the final transform to the 3D US image to obtain a registered US image, and output the registered US image.

In one embodiment, the enhancing filter is further adapted to resample at least one of the 3D US and contrast enhanced CT images.

### BRIEF DESCRIPTION OF THE DRAWINGS

Further features and advantages of the present invention will become apparent from the following detailed description, taken in combination with the appended drawings, in which:

FIG. 1 is a flow chart illustrating a method of registering ultrasound and CT images, in accordance with an embodiment;

FIG. 2 is a flow chart illustrating a method of enhancing blood vessels in a US or CT image, in accordance with an embodiment;

FIG. 3 is a flow chart illustrating a method of determining a spatial transform between an ultrasound image and a CT image, in accordance with an embodiment;

FIG. 4A presents an exemplary ultrasound image;

FIG. 4B presents the ultrasound image of FIG. 4A in which blood vessels have been enhanced;

FIG. 5A presents an exemplary contrast enhanced CT image;

FIG. 5B presents the contrast enhanced CT image of FIG. 5A in which blood vessels have been enhanced; and

FIG. 6 is a block diagram of a system for registering an ultrasound image and a CT image, in accordance with an embodiment.

It will be noted that throughout the appended drawings, like features are identified by like reference numerals.

### DETAILED DESCRIPTION

When they are taken using different medical technologies such as ultrasonography and CT, medical images of a same body portion or part usually have different coordinate systems. A comparison of two images requires that the two images share a same coordinate system so that a same view of the imaged body part may be compared on the two images. Therefore, the two images needs to be registered, i.e. the coordinate system of one of the two images needs to be aligned with the coordinate system of the other image so that both images share the same coordinate system.

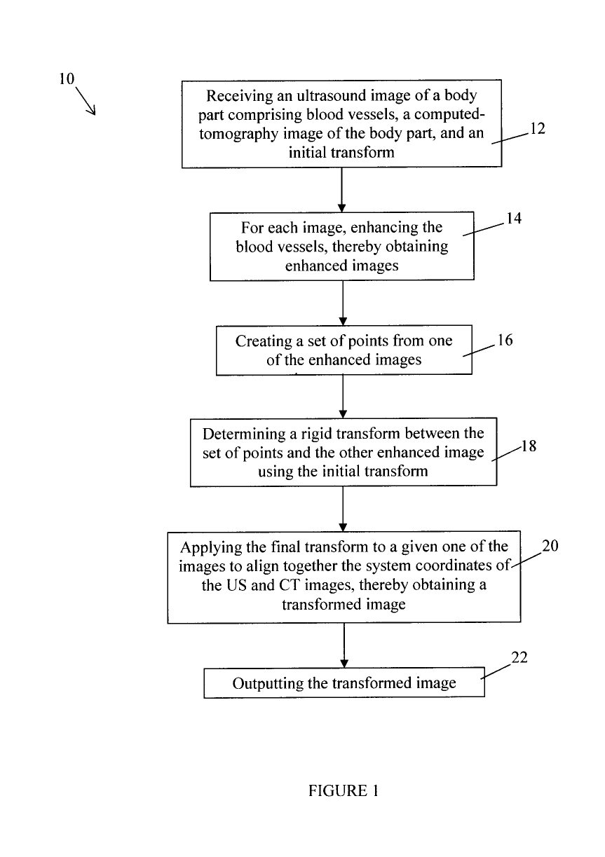

FIG. 1 illustrates one embodiment of a computer-implemented method 10 for registering an ultrasound (US) image and a CT image together so that the two images share a same coordinate system. The person skilled in the art will understand that the method 10 may be used to register the US image to the CT image, i.e. to align the coordinate system of the US image with that of the CT image. Alternatively, the method 10 may be used to register the CT image to the US image, i.e. to align the coordinate system of the CT image with that of the US image.

The method 10 is implemented by a computer machine provided with at least one processor or processing unit, a memory or storing unit, and communication means for receiving and/or transmitting data. Statements and/or instructions are stored on the memory, and upon execution of the statements and/or instructions the processor performs the steps of the method 10.

At step 12, the processor receives two images to be registered, i.e. the US image and the CT image. The CT image is a contrast enhanced CT image taken using any adequate CT imaging system. The US image is a three-dimension (3D) US image taken using any adequate ultrasonography imaging system. The US and CT images both illustrate a same body part of a patient but they are taken with different imaging technologies, i.e. ultrasonography imaging and CT imaging, respectively. The body part contains blood vessels and may be any vascular organs or body structure. For example, the body portion may a liver or a kidney, or a portion of a liver or kidney. In another example, the body portion may be the neck portion comprising the carotid arteries. Usually, the two images have different coordinate systems. At step 12, an initial rigid spatial transform is further inputted by a user and received by the processor. The initial rigid spatial transform is adapted to approximately transform the US image into the coordinate system of the CT image or vice-versa. In one embodiment, the initial rigid spatial transform is manually determined by an operator such as a medical staff person, a medical technician, a surgeon, or the like.

At step 14, the blood vessels contained in the illustrated body part are enhanced for each one of the US and CT images, thereby obtaining an enhanced US image and an enhanced CT image.

The US and CT images are each 3D images and they are each divided into voxels each having a respective 3D position and a respective assigned original value, i.e. an original ultrasound value for each voxel of the US image and an original CT value for each voxel of the CT image.

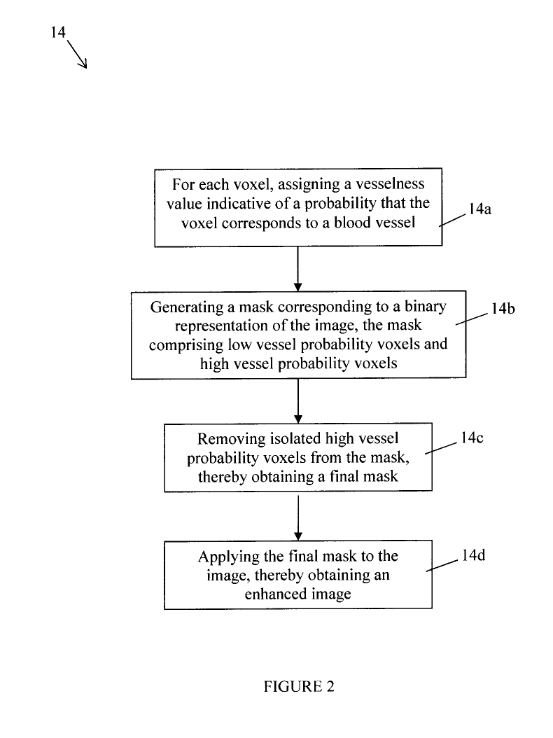

FIG. 2 illustrates one embodiment of the step 14 for enhancing blood vessels in the CT and US images. It should be understood that the method underlying step 14 is applied to both the US and CT images. At step 14a, for each voxel of each image, a vesselness value is assigned to the voxel. It should be understood that any adequate method for determining a vesselness value may be used. The vesselness value is indicative of the probability for the corresponding voxel to correspond to a vessel structure, i.e. to lie on a blood vessel or be close to a blood vessel. Therefore, if a first voxel has a vesselness value that is greater than that of a second voxel, then the first voxel has a greater probability to lie on a vessel or to be adjacent to a vessel than the second voxel. For each one the US and CT images, a respective preprocessed image is generated by assigning the determined vesselness value to each voxel. The US preprocessed image comprises the same voxels as those contained in the original US image and a respective vesselness value is assigned to each voxel of the US preprocessed image. Similarly, the CT preprocessed image comprises the same voxels as those contained in the original CT image and a respective vesselness value is assigned to each voxel of the CT preprocessed image.

At step 14b, an initial mask is generated for each preprocessed image, i.e. for each one of the preprocessed CT and US images. The initial mask corresponds to a binary representation of the preprocessed image, i.e. the initial mask comprises the same voxels as those contained in the corresponding preprocessed image and a mask value is associated to each voxel of the initial mask. The mask value can take one of two possible values, such as zero or one. The initial mask is generated by thresholding the vesselness value of voxels contained in the preprocessed image with respect to a predefined value such as 0.1% of the maximum vesselness value. For example, all voxels in the preprocessed image having a vesselness value that is less 0.1% of the maximum vesselness value are assigned a first mask value such as a zero mask value in the initial mask. All voxels in the preprocessed image having a vesselness value that is equal to or greater than 0.1% of the maximum vesselness value are assigned a mask value equal to a second and different mask value such as a non-zero value (e.g. one) in the initial mask.

At step 14c, a connected component analysis is performed on the initial mask to identify isolated high vessel probability voxels and keep only mask structures which comprise by more than one voxel. This allows removing clutter caused by isolated voxels of which the mask value is equal to one. Since vessels are substantially large structures, one would expect that if a given voxel is a high vessel probability voxel, at least some of its neighbors should also be high vessel probability voxels. If not, the given voxel is considered to have been classified as a high vessel probability voxel by mistake and is therefore considered as being an isolated high vessel probability voxel. It should be understood that any adequate connected components analysis method may be used to detect such isolated voxels.

The mask value of the determined isolated high vessel probability voxels contained in the initial mask is then changed from one to zero, thereby obtaining a final mask.

At step 14d, each final mask is applied to its respective preprocessed image, i.e. the final US mask is applied to the preprocessed US image and the final CT mask is applied to the preprocessed CT image. Each voxel of the original image is compared to its respective voxel in the final mask. If the mask value of the respective voxel in the final mask is equal to zero, then the vesselness value of the voxel in the preprocessed image is set to zero. If the mask value of the respective voxel in the final mask is equal to one, then the vesselness value of the voxel in the preprocessed image remains unchanged.

In one embodiment, the step 14c of determining isolated high vessel probability voxels and assigning a zero vesselness value to the isolated high vessel probability voxels may be omitted.

In one embodiment, the CT image is further processed as follows. The original CT value of each voxel of the CT image is compared to a first CT value threshold and/or a second CT value threshold in order to eliminate voxels whose CT value is outside a range of expected CT values for of blood vessels. In an example in which the CT value of voxels is given in Hounsfield units (HU), the first threshold may be equal to about −100 HU and the second threshold may be equal to +300 HU. All voxels having a CT value below −100 HU or above +300 HU may be excluded, i.e. they may be considered as not belonging to a blood vessel. In this case, their vesselness value is set to zero. It should be understood that this optional step may be performed prior to step 14 to reduce the overall computational time.

Referring back to FIG. 1, a point-set or set of points is generated at step 16 from a first one of the enhanced US and CT images by identifying voxels from the given image that are likely considered as being part of a vessel structure. The voxels that are not unlikely part of a vessel are not introduced into the point-set. In one embodiment, step 16 comprises comparing the vesselness value of each voxel of the first enhanced image to a predefined vesselness value. The point-set only comprises the voxels of which the vesselness value is greater than the predefined vesselness value.

For example, each voxel of which the corresponding vesselness value is greater than or equal to 1% of the maximum determined vesselness value is included in the point-set. All voxels of which the determined vesselness value is less than 1% of the maximum determined vesselness value is not included in the point-set.

At step 18, a rigid spatial transform that allows aligning together the point-set and the second image is determined using the initial rigid spatial transform. It should be understood that any adequate method for determining a spatial transform between a point-set and an image may be used.

In one embodiment, the spatial transform is adapted to align the coordinate system of the point-set with that of the second image. In another embodiment, the spatial transform is adapted to align the coordinate system of the second image with that of the point-set.

In one embodiment, the step 16 comprises the generation of a point-set from the CT image, i.e. a CT point-set. In this case, a spatial transform adapted to align together the coordinate systems of CT point-set and the US image is determined at step 18. For example, the spatial transform may align the coordinate system of the CT point-set with that of the US image. In another example, the spatial transform may align the coordinate system of the US image with that of the CT point-set.

In another embodiment, the step 16 comprises the generation of a point-set from the US image, i.e. a US point-set. In this case, a spatial transform adapted to align together the coordinate systems of US point-set and the CT image is determined at step 18. For example, the spatial transform may align the coordinate system of the US point-set with that of the CT image. In another example, the spatial transform may align the coordinate system of the CT image to that of the US point-set.

At step 20, the determined spatial transform is applied to a given one of the original US and CT images in order to align their coordinate systems and obtain a spatially transformed image. In an embodiment in which it is adapted to align the coordinate system of the point-set with that of the second image, the spatial transform is applied to the first original image from which the point-set has been created so as to align the coordinate system of the first original image with that of the second original image. For example, if the point-set has been created from the CT image, then the spatial transform is applied to the CT image to align the coordinate system of the CT image with that of the US image.

In an embodiment in which it is adapted to align the coordinate system of the second image to that of the point-set, the spatial transform is applied to the second image so as to align the coordinate system of the second image with that of the first image from which the point-set has been created. For example, if the point-set has been created from the CT image, then the spatial transform is applied to the US image to align the coordinate system of the US image with that of the CT image. Alternatively, the spatial transform may be applied to the CT image to align the coordinate system of the CT image with that of the US image

At step 20, the transformed image, i.e. the image of which the coordinate system has been aligned with that of the other image, is outputted. For example, the transformed image may be stored in a local memory. In another example, the transformed image may be transmitted to a display unit to be displayed thereon.

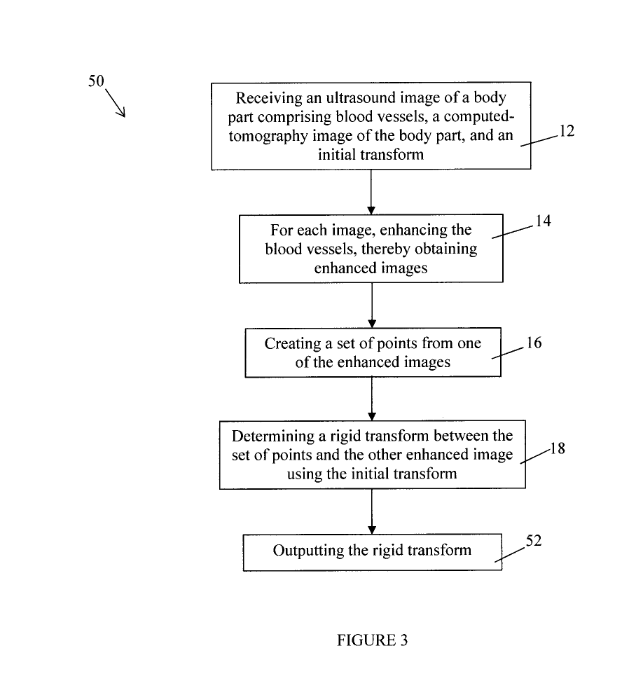

The person skilled in the art will understand that the steps 20 and 22 of the method 10 may be omitted, as illustrated in FIG. 2. FIG. 3 illustrates one embodiment of a method 50 of determining a spatial rigid transform adequate for registering a US image and a CT image. The method 50 comprises the steps 12 to 18 of the method 10. Once it has been created at step 18, the spatial rigid transform is not applied to the given image, but outputted at step 52. For example the determined spatial transform may be stored in memory, and subsequently applied to the given image when requested.

In one embodiment, the original CT and/or US images is (are) resampled to a given isotropic resolution such as a 1 mm isotropic resolution before calculating the vesselness value of the voxels. The resampling step may allow saving computational time and memory usage especially for US image in which the resolution along the z-axis may be oversampled.

In the following, an exemplary embodiment of the method 10 is described. In this embodiment, a CT point-set is generated from a CT image and a rigid spatial transform between a US image and the CT point-set is determined in order to register the US and CT images.

In this exemplary registration method, three inputs, i.e. a 3D CT image such as a contrast enhanced 3D CT image of a liver, a 3D US image such as a 3D US image showing portion of the liver, and an initial rigid spatial transform which approximately registers the CT and US images are received. The initial rigid spatial transform is generated by the user. In one embodiment, the initial rigid spatial transform is required to be sufficiently close to the ideal or true registration but does not have to be perfect. The goal of the registration method is to refine the initial rigid spatial transform in a sense that the output of the method is a rigid spatial transform which is more accurate than the rigid spatial transform for registering the two images and yields better alignment between the images with respect to the initial registration.

As described above, the US and CT images are first preprocessed to enhance blood vessels and optionally suppress other structures. Then, the preprocessed or enhanced images are registered using an intensity based method.

### Preprocessing—Blood Vessel Enhancement

In one embodiment, the preprocessing stage requires producing accurate output images for both CT and US modalities. Accuracy may be measured by two factors. The first factor may be specificity which means that if it has a relatively high vesselness value in the output image, a voxel is in fact on a vessel. The second factor may be sensitivity which means that if it is on a vessel, a voxel will have a relatively high vesselness value in the output image. In the preprocessing stage, a filter is applied to the images in order to enhance the blood vessels therein.

In one embodiment, the same filter is applied to both the US and CT images. The filter traverses all of the voxels of the input image and calculates, for each voxel, a vesselness value which positively correlates with the probability that the voxel lies on a vessel centerline by looking at the cross section of a potential vessel with a given radius centered at that voxel. The vessel cross-section is estimated by calculating the orientation of the centerline of the potential vessel center at the voxel. The orientation of the centerline is defined by the tangent line. If a vessel enhancement in a certain range of radii is desired, the filter should be applied several times with different radii parameters since the filter is tuned to detect tubular objects with a given radius, and in the final result the maximum response should be taken.

In one embodiment, the enhancement of the images is performed in two steps. An orientation calculation is first performed, and then a response function is calculated.

### Orientation Calculation

At this step, the blood vessels to be enhanced within the images are considered as being tubular objects of which the local orientation is to be determined.

In one embodiment, the local orientation of a tubular object is calculated by computing an eigen decomposition of a Hessian matrix, which is the matrix of second derivatives of the image. This approach is based on treating a vessel as an intensity ridge of the image and estimating the direction of the ridge. Using a second degree Taylor expansion of the image intensity, it can be shown that the direction of the ridge corresponds to the eigenvector with the smallest eigenvalue of the hessian matrix (assuming the vessel is brighter than the background in the image).

In another embodiment, the local orientation is determined using a structure tensor method. In this case, the local orientation is determined from an analysis of image gradient directions in the neighborhood of the voxels considering that the gradient magnitude for voxels is strongest at the walls of the vessels compared to that in the inside of the vessel and within a small neighborhood of the vessel outside the vessel. Moreover the gradient vectors point inwards towards the centerline of the vessel if the vessel is bright and outwards from the centerline if the vessel is dark. As a result, if a voxel lies on the centerline of a vessel, the strongest gradients in its neighborhood will be substantially perpendicular to the tangent of the centerline. This direction can be estimated by eigen decomposition of the local structure tensor matrix which is the covariance of the gradient vectors in the neighborhood of the voxel.

In one embodiment, the structure tensor method for determining the local orientation is preferred over the method using the Hessian matrix since it involves only first derivatives compared second derivatives when the Hessian matrix method is used and the use of second derivatives may be detrimental when applied to a noisy US image.

In the following an exemplary structure tensor method is described. Let I be an image which is a function [symbol] ³→ [symbol] . Let G_{σ} be a multivariate Gaussian kernel with standard deviation σ, and let ∇_{σ}I be the gradient of the image I obtained by the convolution with the derivatives of kernel Gσ and multiplied by σ for scale space normalization. The local structure tensor of an image is defined as the outer product of the gradient smoothed by a second Gaussian:

T_{σ}_{₁}_{,σ}_{₂}=G_{σ}_{₂}*(∇_{σ}_{₁}I·∇_{σ}_{₁}I^{t}) (Eq. 1)

For a maximum response for vessel with radius r, the values σ₁ and σ₂ should be set according to Equation 2:

$${σ}_{1} = \frac{r}{\sqrt{2}} {σ}_{2} = \frac{r}{2 \sqrt{2}} \qquad ( Eq . 2 )$$

T_{σ}_{₁}_{,σ}_{₂} is the matrix of the image at each voxel. Denote μ1≧μ2≧μ3 as eigenvalues of T_{σ}_{₁}_{,σ}_{₂} and e₁, e₂, e₃ are the corresponding eigenvectors normalized to unit magnitude. e₃ gives the best fit estimate of the direction perpendicular to the strongest gradients in the neighborhood of the voxel. Thus, e₃ corresponds to the estimate of centerline tangent's direction, and e₁, e₂, which are orthogonal to e₃, span the cross section plane. Once the direction is determined, a response function which looks at the cross-sectional plane is determined such that it gives a high response for tubular objects.

### Response Function

The estimate of the centerline tangent direction also yields an estimate of the cross-section of the vessel. The filter enhances vessels with specific radius so that the former provides the estimated location of the circumference of the vessel in the plane. If indeed the inspected voxel is located on the centerline of the vessel with the corresponding radius, then it is expected to have the vessel walls at the estimated circumference. The response function analyzes the image gradients at the estimated circumference and provides a numerical value that is indicative of how well the image gradients fit the vessel cross-section model. The response function comprises three terms which look at different aspects of the distribution of the gradients and are multiplicatively combined together to yield the final response result.

The first term of the response function corresponds to the sum of the gradient projections on the radial direction across the estimated circumference. As mentioned above, it is expected to have strong gradient responses along the circumference as a result of the vessel walls. Furthermore, all the projections of the gradients on the radial vector along the circumference should be negative in case of a brighter vessel, or positive in case of a darker vessel. A low sum of gradient projections reduces the probability that a vessel is present because it can happen in two cases: either the absolute value of the gradient along the circumference is low which stands in contradiction to the requirement for strong gradients along the vessel walls, or there are both negative and positive projection terms which cancel each other out which contradicts the requirement for the terms to be all negative or all positive. Mathematically, let us define the integral F_{σ}(x):

$$\begin{matrix}{F}_{σ} ( x ) = \frac{1}{2 πτσ} {\int }_{α = 0}^{2 π} {∇}_{σ} I ( x + τσ {v}_{α} ) \cdot {v}_{α} d α & ( Eq . 3 ) \\ where \text{:} & \\ {v}_{α} = {e}_{1} cos α + {e}_{2} sin α α ∈ [ 0 , 2 π ] & ( Eq . 4 )\end{matrix}$$

and where x is the 3D coordinate of the voxel in the image. σ=σ₁ F_{σ}(x) integrates the gradient in the direction towards x over a circle centered at x and having a radius τσ√. In one embodiment, the optimal value for σ is about √3.

In one embodiment, the expression for F_{σ}(x) is calculated using summation instead of integration, as follows:

$${F}_{σ} ( x ) = \frac{1}{N} {\sum }_{i = 1}^{N} {∇}_{σ} I ( x + τσ {v}_{{α}_{i}} ) \cdot {v}_{{α}_{i}} \qquad ( Eq . 5 )$$

where

$${α}_{i} = \frac{2 π}{N} i$$

and N is the number of radial samples used. We used N=20.

Since the vessels could be darker than the background (e.g. for the US image) or brighter than the background (e.g. for the CT image) the value of F_{σ} (x) can be either negative or positive. We therefore define a function B_{σ}(x) as follows:

$${B}_{σ} ( x ) = \{ \begin{matrix}- {F}_{σ} ( x ) , & vessel is brighter than background \\ {F}_{σ} ( x ) , & vessel is darker than background\end{matrix} \qquad ( Eq . 6 )$$

B_{σ}(x)<0 indicates that the structure is unlikely a vessel. Therefore we define the first term of the response function as:

$${B}_{σ}^{+} ( x ) = \{ \begin{matrix}0 , & {B}_{σ} ( x ) < 0 \\ {B}_{σ} ( x ) , & {B}_{σ} ( x ) \geq 0\end{matrix} \qquad ( Eq . 7 )$$

The second term of the response function measures the variability of the radial gradient magnitude along the circumference of the vessel. The vessel is assumed to be radially symmetric and the radial intensity gradient therefore should be substantially constant along its circumference. A high variance means important differences in gradient magnitude in different part of the circumference which lowers the probability of the central voxel being on the centerline. Mathematically, we denote the individual terms which constitute the summation in Equation 5:

fᵢ(αᵢ)=∇_{σ}I(x+τσv_{α}_{ᵢ})·v_{α}_{ᵢ} (Eq. 8)

Let F_{std} be the standard deviation of these terms. The second term is expressed as:

$${P}_{homogenity} ( x ) = {e}^{- {( 2 \cdot \frac{{F}_{std} ( x )}{{B}_{σ}^{+} ( x )} )}^{2}} \qquad ( Eq . 9 )$$

This term is set to 0 if B_{σ}⁺(x)=0.

The third term of the response function is related to the fact that for tubular structures, the image gradient on the circumference should be pointing substantially to the center. In other words, the norm of the vector difference between gradient and its projection in the radial direction should be minimized. Mathematically we define the average difference F_{rad} over the circumference as follows:

$${F}_{ra d} ( x ) = \frac{1}{N} {\sum }_{i = 1}^{N} ‖ {∇}_{σ} I ( x + τσ {v}_{{α}_{i}} ) - {f}_{i} ( x ) {v}_{{α}_{i}} ‖ \qquad ( Eq . 10 )$$

and then third term P_{rad} is defined as

$${P}_{ra d} ( x ) = {e}^{- {( 2 \cdot \frac{{F}_{std} ( x )}{{B}_{σ}^{+} ( x )} )}^{2}} \qquad ( Eq . 11 )$$

This term is set to 0 if B_{σ}⁺(x)=0.

Finally the three terms are combined to provide the response function M_{σ}(x):

M_{σ}(x)=B_{σ}⁺(x)P_{rad}(x)P_{homogenity}(x) (Eq. 12)

In order to detect the vessels with a given range of different radii, the above-described process is repeated for different radii and the maximum scale response M(x) is determined for each voxel:

M(x)=max_{σ}(M_{σ}(x)) (Eq. 13)

The determined M(x) value for a given voxel is indicative of the probability for the voxel to correspond to a vessel, i.e. to be positioned on a vessel. For registration of US and CT liver images, vessels between about 2 mm and about 7 mm in radius are enhanced. We used 5 equally spaced radii in this range (namely: 2.0, 3.25, 4.5, 5.75 and 7.0 mm).

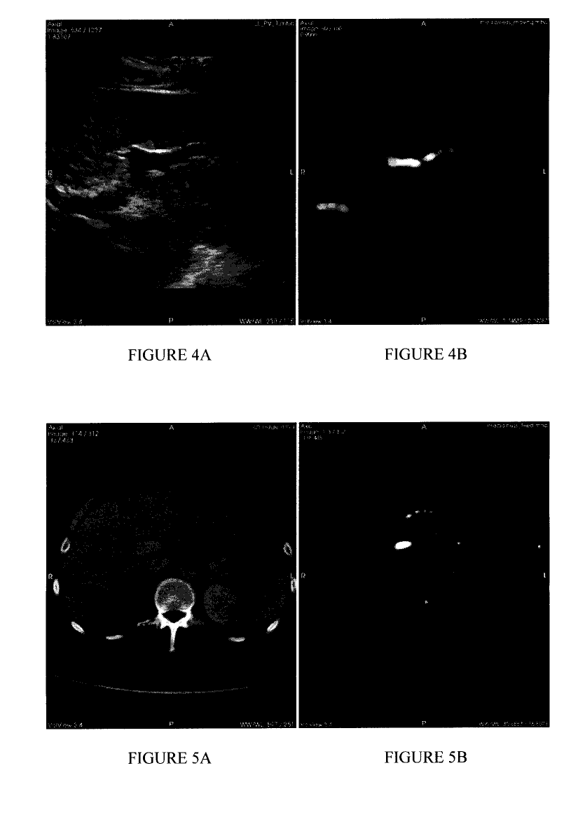

FIG. 4A illustrates an exemplary US image of a liver and FIG. 4B illustrates the corresponding enhanced US image. The enhanced US image corresponds to the US image of FIG. 4A in which the blood vessels has been enhanced using the above-described vessel enhancing method.

FIG. 5A illustrates an exemplary CT image and FIG. 5B illustrates the corresponding enhanced CT image. The enhanced US image corresponds to the CT image of FIG. 5A in which the blood vessels has been enhanced using the above-described vessel enhancing method.

Once the blood vessels have been enhanced in the received US and CT images, thereby obtaining the enhanced US and CT images, a rigid spatial transform is determined. In the present example, the point-set is generated from the CT image and a rigid spatial transform adapted to transform the coordinate system of the CT point-set into the coordinate system of the US image. Once it has been determined, the rigid spatial transform is applied to the CT image or the CT enhanced image in order to register the US and CT images or the enhanced US and CT images

### Point Set to Image Registration

In order to register the images, the first step consists in determining a rigid transform adapted to register the CT image to the 3D US image such that:

T(x_{CT})=Rx_{CT}+o=x_{US} (Eq. 14)

where x_{CT} represents the 3D coordinates of a given point in the CT image, x_{US} represents the 3D coordinates of the given point in the US image, R is a rotation matrix and o is an offset vector. The transform T can be parameterized with 6 parameters as follows: [v₁,v₂,v₃] which is a versor representing the rotation matrix R and [oₓ,o_{y},o_{z}] which represents the offset vector o.

In one embodiment, the blood vessels occupy only a relatively small portion of the CT image. In this case, the majority of the voxels in the CT image, which do not correspond to a blood vessel, have a substantially low vesselness value compared to the voxels located on a blood vessel. Thus if the low vesselness value voxels are ignored, the preprocessed CT image becomes sparse and a point-set containing only high vesselness value voxels may be created. The registration then uses a rigid transform between the CT point-set and the US image. The calculation of the point-set to image registration is then faster than that of an image to image registration since a metric calculation is only needed for a subset of the voxels in the CT enhanced image rather than for the whole image.

Once the point-set P has been created using the above-described method, the transform T between the point-set P and the enhanced US image is determined. The transform T is adapted to maximize the average vesselness value of the voxels contained in the enhanced US image to which the voxels of the point-set P map. A transform T that maximizes the former allows mapping high vesselness value CT voxels to high vesselness value US voxels, and therefore yielding image alignment.

The following metric parameter is defined:

$$MSD ( T , P , {V}_{US} ) = \frac{1}{‖ P ‖} {\sum }_{x ∈ P}^{ } {( c - {M}_{US} ( T ( x ) ) )}^{2} \qquad ( Eq . 15 )$$

where M_{US} represents the vesselness value of the voxels for the enhanced US image and c is a constant. The metric parameter MSD corresponds to a mean squared difference between the enhanced US image and the CT point-set P, if each point in the point-set P has a value c associated it. In one embodiment, the value of the constant c is greater than the maximum value of M_{US} so that each difference (c-M_{US}(T(x)) is always positive. Thus for each term (c-M_{US}(T(x)), the higher the value of M_{US} is, the lower the value of MSD is. On the other hand, the terms (c-M_{US}(T(x)) for which a point in point-set P maps to a low intensity voxel in M_{US} will increase the metric parameter MSD. Therefore minimizing the metric parameter MSD allows mapping the most high probability vessel voxels in the CT point-set to high probability voxels in the US image. The transform T that provides the minimized metric parameter MSD corresponds to the desired transform.

In one embodiment, the constant c is set to about 100.

In one embodiment, the MSD metric parameter is minimized with respect to the parameterization of the transform T using a gradient descent optimization method. The optimization starts using the initial rigid transform received as an input. The initial transform may be sufficiently close to the solution. The optimization iteratively tries to improve the solution by taking steps in the parametric space along the direction of the negative gradient of the metric parameter MSD. The process stops when a minimum of the metric parameter MSD is reached or a given number of iterations is reached.

In one embodiment, a multi-scale optimization approach is used to ensure that the determined minimum of the metric parameter MSD is not a local minimum, which could provide an inadequate final transform T. In this case, the image is blurred with Gaussian kernels with decreasing scale (i.e. variance). For the first image, which has the highest scale, the optimization is initialized with the initial rigid transform. For the other images, the optimization is started from the final transform of the previous scale level. In one embodiment, three scales are used with the following variances in millimeter units: 4.0, 2.0, and 1.0.

The above-described methods may be embodied as a computer readable memory having recorded thereon statements and instructions that, upon execution by a processing unit, perform the steps of method 10, 14, and/or 50.

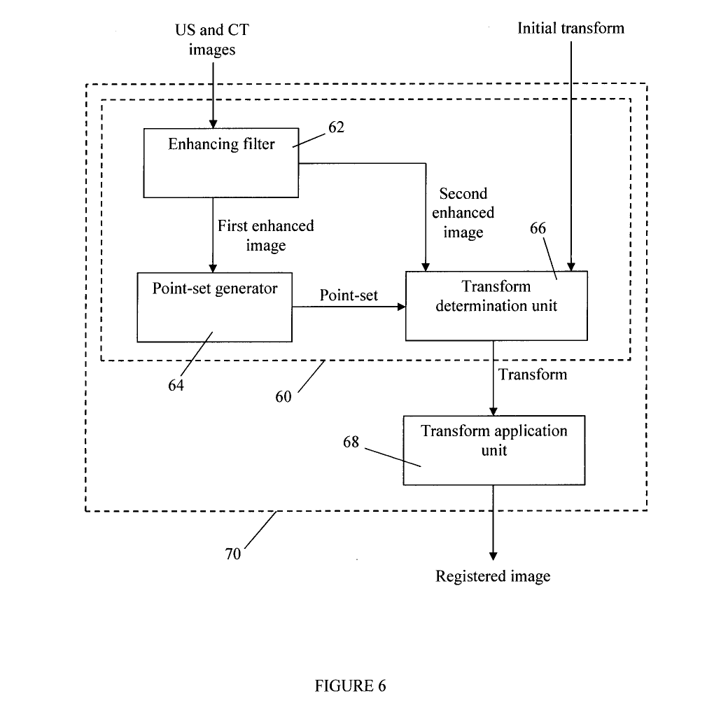

The above-described method 10, 50 may also be embodied as a system as illustrated in FIG. 6. FIG. 6 illustrates one embodiment of a system 60 for generating a rigid spatial transform adapted to register a US image and a CT image. The system 60 comprises an enhancing filter 62, a point-set generator 64 and a transform determination unit 66, which may each be provided with at least one respective processing unit, a respective memory, and a respective communication unit for receiving and transmitting data. Alternatively, at least two of the enhancing filter 62, the point-set generator 64 and the transform determination unit 66 may share a same processing unit, a same memory, and/or a same communication unit. It should be understood that the processing unit(s) is (are) adapted to perform the above-described method steps.

The enhancing filter 62 is adapted to receive the two images to be registered, i.e. a US image and a CT image. The enhancing filter 62 is adapted to enhance the blood vessels present in both the US image and the CT image using the above-described method. The enhancing filter 62 transmits a first one of the two enhanced images, e.g. the enhanced CT image, to the point-set generator 64 and the second enhanced image, e.g. the enhanced US image, to the transform determination unit 66. It should be understood that the enhancing filter 62 is adapted to perform the step of the method 14 illustrated in FIG. 2

The point-set generator 64 receives the first enhanced image and is adapted to generate a point-set from the received enhanced image using the above-described method. The point-set generator 64 further transmits the generated point-set to the transform determination unit 66.

The transform determination unit 66 receives the point-set generated from the first enhanced image, the second enhanced image, and an initial rigid spatial transform. As described above, the initial rigid spatial transform represents an approximate transform that approximately register the two images relative to the ideal or true transform that precisely registers the two images. The initial rigid spatial transform may be manually determined by a user.

The transform determination unit 66 is adapted to determine a final rigid spatial transform between the point-set and the second enhanced image using the initial rigid spatial transform and the above-described method. The final rigid spatial transform represents an improved transform relative to the initial rigid spatial transform, i.e. its precision in aligning the two images together is greater to that of the initial rigid spatial transform and closer to that of the ideal transform relative to the initial rigid transform.

The final rigid spatial transform outputted by the transform determination unit 66 may be stored in memory. In same or another embodiment, the final rigid spatial transform is sent to a transform application unit 68 which is part of a system 70 for registering the US and CT images. The system 70 comprises the enhancing filter 62, the point-set generator 64, the transform determination unit 66, and the transform application unit 68. The transform application unit 68 receives the initial US and CT images to be registered and the final rigid spatial transform and is adapted to apply the final rigid spatial transform to one of the two received images. In an embodiment in which the final rigid spatial transform is adapted to align the coordinate system of the US image with that of the CT image, the transform application unit 68 is adapted to apply the final rigid spatial transform to the US image so that the US and CT images share the same coordinate system, i.e. the coordinate system of the CT image. In an embodiment in which the final rigid spatial transform is adapted to align the coordinate system of the CT image with that of the US image, the transform application unit 68 is adapted to apply the final rigid spatial transform to the CT image so that the US and CT images share the same coordinate system, i.e. the coordinate system of the US image.

The registered image, i.e. the US or CT image to which the final rigid spatial transform has been applied to transform its coordinate system, is outputted by the transform application unit 68. For example, the registered image may be stored in memory. In another example, the registered image may be displayed on a display unit (not shown).

The embodiments of the invention described above are intended to be exemplary only. The scope of the invention is therefore intended to be limited solely by the scope of the appended claims.

1. A computer-implemented method for registering an ultrasound (US) image and a computed tomography (CT) image together, comprising:
use of at least one processing unit for receiving a three-dimensional (3D) US image representative of a body portion comprising blood vessels, a contrast enhanced CT image representative of the body portion, and an initial transform providing an approximate registration of the 3D US and contrast enhanced CT images together;
use of the at least one processing unit for enhancing the blood vessels in each one of the 3D US and contrast enhanced CT images, thereby obtaining a vessel enhanced US image and a vessel enhanced CT image;
use of the at least one processing unit for creating a point-set for a given one of the vessel enhanced US and CT images;
use of the at least one processing unit for determining a final transform between the point-set and the other one of the vessel enhanced US and CT images using the initial transform;
use of the at least one processing unit for applying the final transform to a given one of the 3D US and enhanced contrast CT images to align together a coordinate system of the 3D US image and a coordinate system of the enhanced contrast CT image, thereby obtaining a transformed image; and
use of the at least one processing unit for outputting the transformed image.

2. The computer-implemented method of claim 1, wherein said enhancing the blood vessels comprises, for each voxel of each one of the 3D US and contrast enhanced CT images:
determining a vesselness value indicative of a probability for the voxel to correspond to one of the blood vessels; and
assigning the determined vesselness value to the voxel, thereby obtaining a preprocessed US image and a preprocessed CT image.

3. The computer-implemented method of claim 2, wherein said enhancing said blood vessels comprises for each one of the preprocessed US and preprocessed CT images:
generating a binary mask comprising high vessel probability voxels and low vessel probability voxels; and
applying the binary mask to a respective one of the preprocessed CT and preprocessed US images.

4. The computer-implemented method of claim 3, wherein said generating the binary mask comprises:
comparing the vesselness value of each voxel to a first predefined value;
assigning a first mask value to first voxels of the binary mask having a vesselness value being less than the first predefined value, thereby obtaining the low vessel probability voxels; and
assigning a second mask to second voxels of the binary mask having a vesselness value being one of equal to and greater than the first predefined value, thereby obtaining the high vessel probability voxels, the second mask value being different from the first mask value.

5. The computer-implemented method of claim 4, said applying the binary mask comprises assigning a zero vesselness value to voxels of the respective one of the preprocessed CT and preprocessed US images that correspond to the low vessel probability voxels in the binary mask.

6. The computer-implemented method of claims 4 further comprising use of the at least one processing unit for identifying isolated voxels among the high vessel probability voxels and assigning the first mask value to the isolated voxels.

7. The computer-implemented method of claim 5, wherein said creating a point-set comprises:
comparing the vesselness value of each voxel to a second predefined value;
identifying given voxels having a vesselness value being greater than the predetermined value; and
storing the given voxels, thereby obtaining the point-set.

8. The computer-implemented method of claim 1, wherein:
said creating the point-set comprises creating a CT point-set from the vessel enhanced CT image;
said determining the final transform comprises determining the final transform between the CT point-set and the vessel enhanced US image;
said applying the final transform comprises applying the final transform to the 3D US image, thereby obtaining a registered US image; and
said outputting the transformed image comprises outputting the registered US image.

9. The computer-implemented method of claim 1, further comprising use of the at least one processing unit for resampling at least one of the 3D US and contrast enhanced CT images.

10. A computer program product comprising a computer readable memory storing computer executable instructions thereon that when executed by a computer perform the method steps of claim 1.

11. A computer-implemented method for determining a transform for registering an ultrasound (US) image and a computed tomography (CT) image together, comprising:
use of at least one processing unit for receiving a three-dimensional (3D) US image representative of a body portion comprising blood vessels, a enhanced contrast CT image representative of the body portion, and an initial transform providing an approximate registration of the 3D US and enhanced contrast CT images together;
use of the at least one processing unit for enhancing the blood vessels in each one of the 3D US and enhanced contrast CT images, thereby obtaining a vessel enhanced US image and a vessel enhanced CT image;
use of the at least one processing unit for creating a point-set for a given one of the vessel enhanced US and CT images;
use of the at least one processing unit for determining a final transform between the point set and the other one of the vessel enhanced US and CT images using the initial transform, the final transform allowing to align a coordinate system of the 3D US image and a coordinate system of the enhanced contrast CT image together; and
use of the at least one processing unit for outputting the final transform.

12. A system for registering an ultrasound (US) image and a computed tomography (CT) image together, comprising:
an enhancing filter for receiving a three-dimensional (3D) US image representative of a body portion comprising blood vessels and a contrast enhanced CT image representative of the body portion, and enhancing the blood vessels in each one of the 3D US and contrast enhanced CT images to obtain a vessel enhanced US image and a vessel enhanced CT image;
a point-set generator for creating a point-set for a given one of the vessel enhanced US and CT images;
a transform determination unit for receiving an initial transform providing an approximate registration of the 3D US and contrast enhanced CT images together and determining a final transform between the point set and the other one of the vessel enhanced US and CT images using the initial transform; and
a transform application unit for applying the final transform to a given one of the 3D US and contrast enhanced CT images to align together a coordinate system of the 3D US image and a coordinate system of the contrast enhanced CT image to obtaining a registered image, and for outputting the registered image.

13. The system of claim 12, wherein the enhancing filter is adapted to, for each voxel of each one of the 3D US and contrast enhanced CT images:
determine a vesselness value indicative of a probability for the voxel to correspond to one of the blood vessels; and
assign the determined vesselness value to the voxel to obtain a preprocessed US image and a preprocessed CT image.

14. The system of claim 13, wherein the enhancing filter is adapted to, for each one of the preprocessed US and preprocessed CT images:
generate a binary mask comprising high vessel probability voxels and low vessel probability voxels; and
apply the binary mask to a respective one of the preprocessed CT and preprocessed US images.

15. The system of claim 14, wherein the enhancing filter is adapted to generate the binary mask by:
comparing the vesselness value of each voxel to a first predefined value;
assigning a first vesselness value to first voxels of the binary mask having a vesselness value being less than the first predefined value, thereby obtaining the low vessel probability voxels; and
assigning a second value to second voxels of the binary mask having a vesselness value being one of equal to and greater than the first predefined value, thereby obtaining the high vessel probability voxels, the second mask value being different from the first mask value.

16. The system of claim 15, the enhancing filter is adapted to apply the binary mask by assigning a zero vesselness value to voxels of the respective one of the preprocessed CT and preprocessed US images that correspond to the low vessel probability voxels of the binary mask.

17. The system of claims 15, wherein the enhancing filter is further adapted to identify isolated voxels among the high vessel probability voxels and assign the first mask value to the isolated voxels.

18. The system of claim 16, wherein the point-set generator is adapted to:
compare the vesselness value of each voxel to a second predefined value;
identify given voxels having a vesselness value being greater than the predetermined value; and
store the given voxels, thereby obtaining the point-set.

19. The system of claim 12, wherein:
the point-set generator is adapted to create a CT point-set from the vessel enhanced CT image;
the transform determination unit is adapted to determine the final transform between the CT point-set and the vessel enhanced US image; and
the transform application unit is adapted to apply the final transform to the 3D US image to obtain a registered US image, and output the registered US image.

20. The system of claim 12, wherein the enhancing filter is further adapted to resample at least one of the 3D US and contrast enhanced CT images.
